(19) United States
(12) Patent Application Publication
(10) Pub. No.: US 2023/0326217 A1
(43) Pub. Date: Oct. 12, 2023

(54) APPARATUS FOR AND METHOD OF CONTROLLING ACTIVATION OF OBJECT DETECTION SENSOR

(71) Applicant: HYUNDAI MOBIS CO., LTD., Seoul (KR)

(72) Inventor: Jae Young LEE, Yongin-si (KR)

(73) Assignee: HYUNDAI MOBIS CO., LTD., Seoul (KR)

(21) Appl. No.: 18/146,923

(22) Filed: Dec. 27, 2022

(30) Foreign Application Priority Data
Mar. 25, 2022 (KR) 10-2022-0037666

(51) Int. Cl. G06V 20/58; G01S 15/931; G06V 10/70; G06V 20/64

(52) U.S. Cl. CPC G06V 20/58; G01S 15/931; G06V 10/70; G06V 20/64

(57) ABSTRACT

An apparatus for controlling activation of an object detection sensor, the apparatus including an image acquisition unit configured to acquire an image of an area in front of the host vehicle, and a controller configured to control the activation of the object detection sensor on the basis of the presence or absence of a free space in front of the host vehicle that is determined from the image of the area in front of the host vehicle that is acquired by the image acquisition unit and on the basis of a relative kinematic relationship between a preceding vehicle extracted from the image of the area in front of the host vehicle and the host vehicle.

### CROSS-REFERENCE TO RELATED APPLICATION

This application claims priority from and the benefit of Korean Patent Application No. 10-2022-0037666, filed on Mar. 25, 2022, which is hereby incorporated by reference for all purposes as if set forth herein.

### BACKGROUND

### Field

The present disclosure relates to an apparatus for and a method of controlling activation of an object detection sensor and, more particularly, to an apparatus for and a method of controlling activation of an object detection sensor, the apparatus and the method being capable of controlling activation and deactivation of a front-side ultrasonic sensor mounted in a vehicle.

### Discussion of the Background

Usually, a rear-side ultrasonic sensor for a vehicle is mounted in a bumper in the rear of the vehicle. When the vehicle is driven backward, the rear-side ultrasonic sensor performs a function of notifying a driver whether or not an obstacle is present behind the vehicle. In recent years, a front-side ultrasonic sensor has also been mounted in a bumper in the front of the vehicle. The front-side ultrasonic sensor is utilized to detect whether or not an obstacle is present in front of the vehicle in a complex traveling environment, such as on an alley, or in a situation where the vehicle is driven out of a parting lot, and to alert a driver to the obstacle.

Usually, the front-side ultrasonic sensor and the rear-side ultrasonic sensor use the same frequency band. Therefore, a front-side ultrasonic sensor of a first vehicle, when set to operate at all times, may operate as a source that causes noise for a front-side ultrasonic sensor or a rear-side ultrasonic sensor of a second vehicle positioned in the vicinity of the first vehicle. Therefore, in a case where the first vehicle of which the front-side ultrasonic sensor is set to operate at all times is present in the vicinity of the second vehicle, there is an increased probability that the front-side ultrasonic sensor or the rear-side ultrasonic sensor of the second vehicle will erroneously detect an object.

In order to solve the above-mentioned problem, there has been proposed a method of activating the front-side ultrasonic sensor only in a case where a driver performs a specific operation. Specifically, in a case where the rear-side ultrasonic sensor is configured to be activated at “Gear Stage R” corresponding to an explicit backward-driving situation and where the front-side ultrasonic sensor is configured to be activated at “Gear Stage D, this configuration is the same as that in a usual traveling situation, and thus the same as when the front-side ultrasonic sensor operates at all times. In the situation as mentioned above, the rear-side ultrasonic sensor of the second vehicle is caused to erroneously detect an object. In order to reduce the probability that the rear-side ultrasonic sensor of the second vehicle will erroneously detect an object, there has been proposed a method of activating the front-side ultrasonic sensor only in a case where a parking distance warning (PDW) switch of the first vehicle is turned on by the driver.

However, in a case where the first vehicle enters a parking lot or an alley having a narrow path, the driver experiences the inconvenience of operating the PDW switch while exercising care to prevent a scratch on a vehicle body to due to collision with a nearby obstacle. Usually, the PDW switch is installed near a gear knob. Therefore, the driver cannot keep his/her eyes on the road while operating the PDW switch. Thus, there occurs a problem in that the risk of an accident is increased.

The background art of the present disclosure is disclosed in Korean Patent Application Publication No. 10-2013-0079877 (published on Jul. 11, 2013).

### SUMMARY

An object of the present disclose, which is contrived to solve the above-mentioned problem, is to provide an apparatus for and a method of controlling activation of an object detection sensor, the apparatus and the method being capable of removing interference with a front-side or rear side ultrasonic sensor of a preceding vehicle located in front of a host vehicle and thus reducing the probability that the front-side or rear side ultrasonic sensor of the preceding vehicle will erroneously detect an object. The apparatus and the method can improve convenience for the driver more than in the case of a technique of controlling activation of a front-side ultrasonic sensor by operation of a PDW switch and can reduce the risk of an accident.

According to an aspect of the present disclosure, there is provided an apparatus for controlling activation of an object detection sensor for detecting an object in front of a host vehicle, the apparatus including: an image acquisition unit configured to acquire an image of an area in front of the host vehicle; and a controller configured to control the activation of the object detection sensor on the basis of the presence or absence of a free space in front of the host vehicle that is determined from the image of the area in front of the host vehicle that is acquired by the image acquisition unit and on the basis of a relative kinematic relationship between a preceding vehicle extracted from the image of the area in front of the host vehicle and the host vehicle.

In the apparatus, when determining the presence or absence of the free space in front of the host vehicle, by analyzing the number of pixels of the image of the area in front of the host vehicle, the controller may determine whether or not a central area in front of the host vehicle, a left-side area to the left of the central area, and a right-side area to the right of the central area correspond to the free space.

In the apparatus, in a case where a ratio of the number of pixels of an image of each of the central area, the left-side area, and the right-side area in which of each the object is detected to the number of the pixels of the image of the area in front of the host vehicle is lower than a preset reference value, the controller may determine that the corresponding area corresponds to the free space.

In the apparatus, when determining the presence of absence of free space in front of the host vehicle, the controller may convert the image of the area in front of the host vehicle to a bird-eye view and then may determine the presence or absence of the free space in front of the host vehicle, using a technique of applying a predefined image processing algorithm to the bird-eye view resulting from the conversion and performing analysis of the number of pixels of the image of the area in front of the host vehicle.

In the apparatus, in a case where the area in front of the host vehicle does not correspond to the free space, the controller may primarily determine that the object detection sensor needs to be activated.

In the apparatus, the controller may extract the preceding vehicle from the image of the area in front of the host vehicle by applying a predefined object detection algorithm to the image of the area in front of the host vehicle and may analyze a relative kinematic relationship between the extracted preceding vehicle and the host vehicle on the basis of an angle between traveling directions of the preceding vehicle and the host vehicle and on the basis of whether or not the traveling directions of the preceding vehicle and the host vehicle are opposite to each other.

In the apparatus, in a case where the angle between the traveling directions of the preceding vehicle and the host vehicle is at or above a preset reference value or in a case where the host vehicle travels forward and where the preceding vehicle travels backward, the controller may secondarily determine that the object detection sensor needs to be deactivated.

In the apparatus, the object detection algorithm may correspond to a 3D object detection network that performs pre-learning in such a manner that the image of the area in front of the host vehicle is set to be input and that 3D positional information of the object present on the input image of the area in front of the host vehicle is output, and the controller may obtain an angle between the traveling directions of the preceding vehicle and the host vehicle from an output of the object detection algorithm.

In the apparatus, the object detection sensor may be a front-side ultrasonic sensor, and a rear-side ultrasonic sensor for detecting the object behind the preceding vehicle may be installed in the preceding vehicle, and, in a case where an output signal value of the front-side ultrasonic sensor that is initially set to be in a reception mode is at or above a preset reference value, after the host vehicle moves a preset distance by traveling at a vehicle speed within a preset speed range, the controller may start to perform an operation of controlling activation of the front-side ultrasonic sensor.

According to another aspect of the present disclosure, there is provided a method of controlling activation of an object detection sensor for detecting an object in front of a host vehicle, the method including: determining, by a controller, the presence or absence of a free space in front of the host vehicle from an image of an area in front of the host vehicle; analyzing, by the controller, a relative kinematic relationship between a preceding vehicle extracted from the image of the area in front of the host vehicle and the host vehicle in a case where the area in front of the host vehicle does not correspond to the free space; and controlling, by the controller, the activation of the object detection sensor on the basis of a result of analyzing the relative kinematic relationship between the preceding vehicle and the host vehicle.

According to the aspects of the present disclosure, a technique of controlling the activation and the deactivation of the front-side ultrasonic sensor according to whether or not the area in front of the host vehicle corresponds to the free space is employed. This technique is more advantageous in terms of an improvement in convenience for the driver and a reduction in the risk of an accident than a technique of controlling the activation of the front-side ultrasonic sensor by operating a PDW switch. Even in a case where an obstacle is present in front of the host vehicle and thus where the front-side ultrasonic sensor needs to be activated, when this activation causes the interference with the object detection operation performed by the front-side or rear-side ultrasonic sensor of the preceding vehicle located in front of the host vehicle, the probability that the ultrasonic sensor of the preceding vehicle will erroneously detect an object can be reduced by deactivating the front-side ultrasonic sensor.

### BRIEF DESCRIPTION OF THE DRAWINGS

FIG. 1 is a view illustrating traveling situations of a preceding vehicle and a host vehicle in which an apparatus for and a method of controlling activation of an object detection sensor according to first and second embodiments, respectively, of the present disclosure find application.

FIG. 2 is a block diagram illustrating the apparatus for controlling activation of an object detection sensor according to the first embodiment of the present disclosure.

FIG. 3 is a flowchart illustrating the method of controlling activation of an object detection sensor according to the second embodiment of the present disclosure.

FIGS. 4 and 5 are views that are referred to for description of a step of determining the presence or absence of a free space from an image of an area in front of the host vehicle in the method of controlling activation of an object detection sensor according to the second embodiment of the present disclosure.

FIGS. 6 and 7 are views that are referred to for description of a step of extracting the preceding vehicle from the image of the area in front of the host vehicle in the method of controlling activation of an object detection sensor according to the second embodiment of the present disclosure.

### DETAILED DESCRIPTION OF THE ILLUSTRATED EMBODIMENTS

An apparatus for and a method of controlling activation of an object detection sensor according to first and second embodiments, respectively, of the present disclosure will be described below with reference to the accompanying drawings. For clarity and convenience in description, thicknesses of lines and sizes of constituent elements may be illustrated in non-exact proportion in the drawings. In addition, a term defined by considering a function of a constituent element according to the present disclosure to which the term is assigned will be used below and may vary according to the user’s or manager’s intention or to practices in the art. Therefore, the term should be defined in context in light of the present specification.

An object detection sensor SEN that is referred to for description of the apparatus for and the method of controlling activation of an object detection sensor according to the first and second embodiments, respectively, of the present disclosure may correspond to a front-side ultrasonic sensor that is installed in the front of a host vehicle (for example, in a front bumper) and detects an object in front of the host vehicle. In addition, a preceding vehicle that is referred to for description of the apparatus for and the method of controlling activation of an object detection sensor according to the first and second embodiments, respectively, of the present disclosure corresponds to a vehicle that travels, moves, or is parked in front of the host vehicle. It is assumed that a rear-side ultrasonic sensor for detecting an object behind the preceding vehicle is installed in the preceding vehicle.

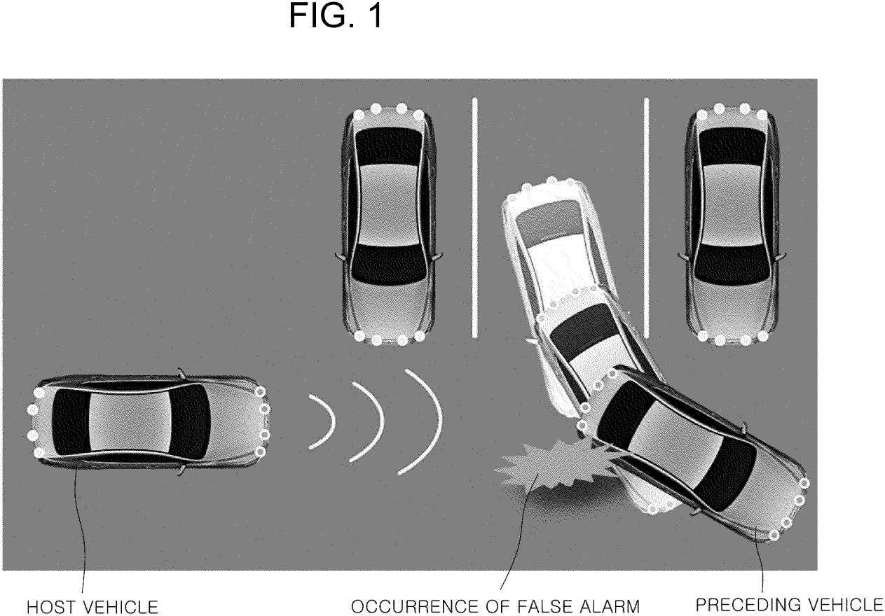

A “critical situation resulting from regular activation of the front-side ultrasonic sensor,” which is associated with the need for application of the apparatus for and the method of controlling activation of an object detection sensor according to the first and second embodiments, respectively, of the present disclosure, is preferentially described. As described above, most operations of a vehicle are associated with forward traveling, and thus, a traveling direction of the preceding vehicle (for example, a vehicle in front of the host vehicle) is the same as a traveling direction of the host vehicle. Therefore, there is a low probability that the front-side ultrasonic sensor installed in the host vehicle, although activated (in a transmission mode), will cause interference with an operation of the ultrasonic sensor installed in the preceding vehicle. However, in a case where the host vehicle or the preceding vehicle changes lanes or abruptly changes a traveling direction, a signal transmitted from the front-side ultrasonic sensor of the host vehicle may be received by the ultrasonic sensor (the front-side or rear-side ultrasonic sensor) of the preceding vehicle. Particularly, as illustrated in FIG. 1, in the case of a situation where the preceding vehicle is vertically parked (backed into a parking space for parking) in front of the host vehicle in a parking area, the signal transmitted from the front-side ultrasonic sensor of the host vehicle reaches the rear-side ultrasonic sensor of the preceding vehicle, and thus causes interference. In this case, there may occur a problem in that a parking assistant system of the preceding vehicle sets off a false alarm, or in that the parking assistant system determines that a properly detected neighboring obstacle (for example, another already-parked vehicle or the like) corresponds to noise and thus does not properly operate.

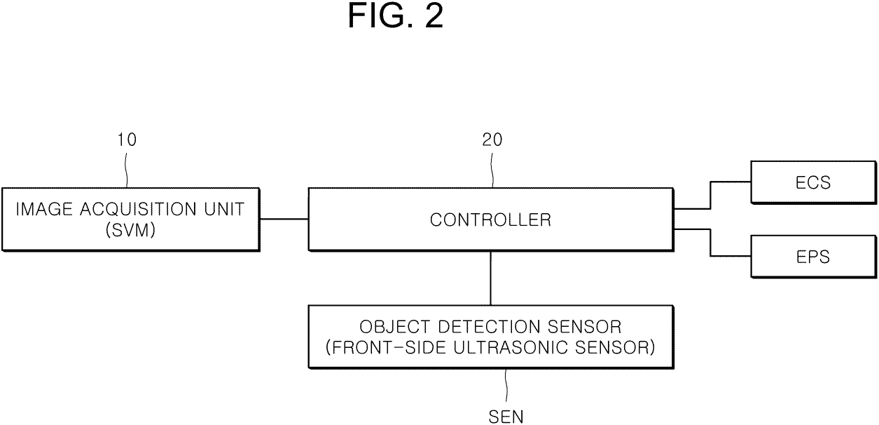

FIG. 2 is a block diagram illustrating the apparatus for controlling activation of an object detection sensor according to the first embodiment of the present disclosure, which is mounted to solve the above-mentioned problems. With reference to FIG. 2, the apparatus for controlling activation of an object detection sensor according to the first embodiment of the present disclosure may include an image acquisition unit 10 and a controller 20. FIG. 2 also illustrates the object detection sensor SEN (that is, the front-side ultrasonic sensor) that is a target for activation control according to the first embodiment of the present disclosure and an electronic stability control (ESC) system and an electronic power steering (EPS) that provide a vehicle speed and a steering angle, respectively, as parameters necessary for a computation and an operation performed by the controller 20 described below. Constituent elements (the object detection sensor SEN, the image acquisition unit 10, the controller 20, the ESC system, and the EPS system) in FIG. 2 are all installed in the host vehicle.

The image acquisition unit 10 may correspond to a surround view monitoring (SVM) system acquiring an image of an area in front of the host vehicle, an image of an area to the left side of the host vehicle, an image of an area to the right side of the host vehicle, and an image of an area behind the host vehicle. Accordingly, the image acquisition unit 10 may be configured to include a front-side camera sensor acquiring the image of the area in front of the host vehicle, a left-side camera sensor acquiring the image of the area to the left side of the host vehicle, a right-side camera sensor acquiring the image of the area to the right side of the host vehicle, and a rear-side camera sensor acquiring the image of the area behind the host vehicle. According to the first embodiment of the present disclosure, focus is placed on the constituent elements that serve to detect the preceding vehicle that is located in front of the host vehicle. Therefore, an operation of acquiring the image of the area in front of the host vehicle through the front-side camera sensor included in the image acquisition unit 10 is mostly described.

The controller 20 is a main constituent element performing an operation of controlling activation of the object detection sensor SEN. The controller 20 may be realized as a processor, a central processing unit (CPU), or a system-on-chip (SoC). The controller 20 may be configured to control a plurality of hardware or software constituent elements connected to the processor by running an operating system or an application, to perform various types of data processing and computation, to execute at least one command stored in a memory, and to store data, resulting from the execution, in the memory.

According to the first embodiment of the present disclosure, the controller 20 may control the activation of the object detection sensor SEN on the basis of the presence or absence of a free space in front of the host vehicle, which is determined from the image of the area in front of the host vehicle and on the basis of a relative kinematic relationship between the preceding vehicle extracted from the image of the area in front of the host vehicle and the host vehicle. An image processing algorithm (a semantic segmentation network described below) for determining the presence or absence of the free space in front of the host vehicle and an object detection algorithm (a 3D object detection network described below) for analyzing the relative kinematic relationship between the preceding vehicle and the host vehicle may be predefined in the controller 20. The controller 20 may be provided with the vehicle speed and the steering angle of the host vehicle, which are required during a control process, from the ESC system and the EPS system, respectively.

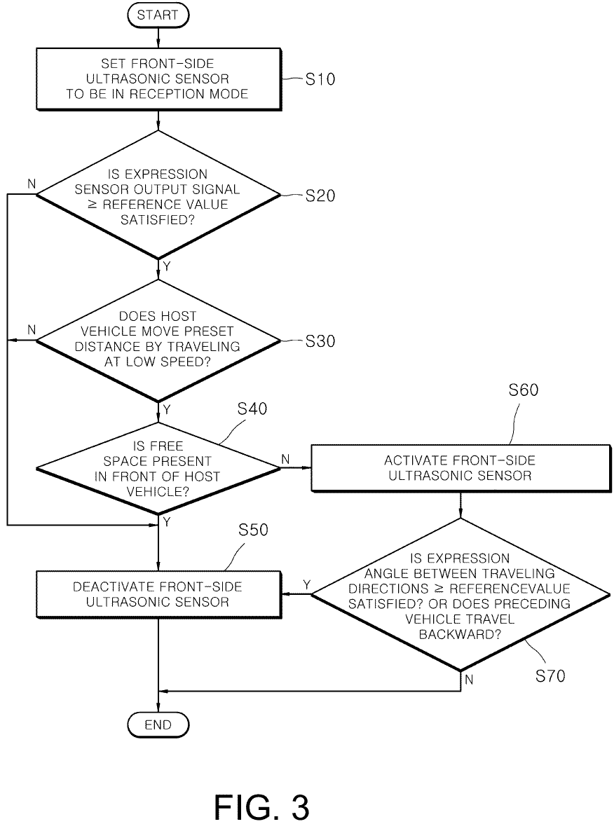

Specific steps of controlling the activation of the object detection sensor SEN will be described in detail below with reference to FIGS. 3 to 7.

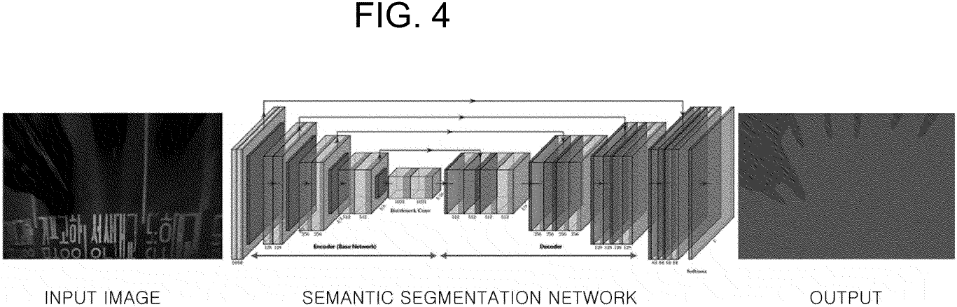

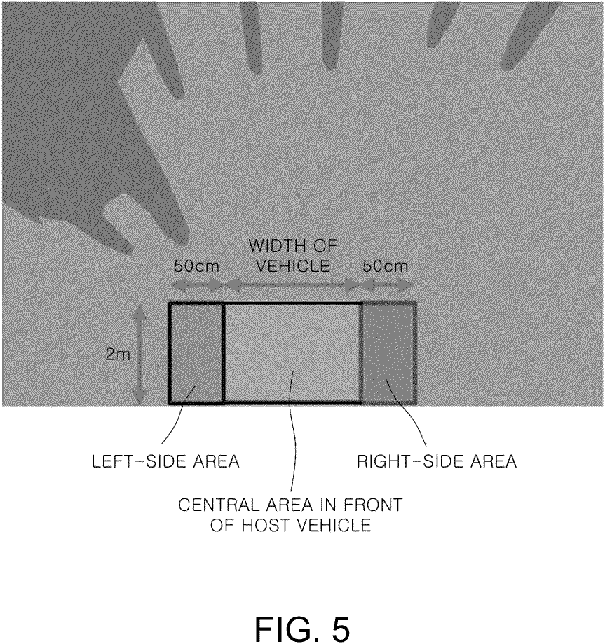

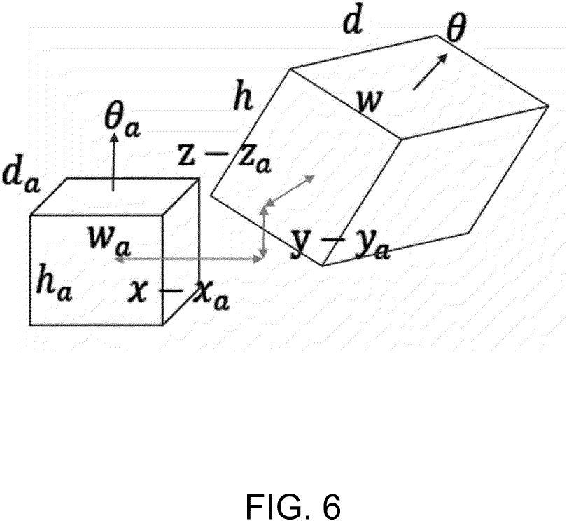

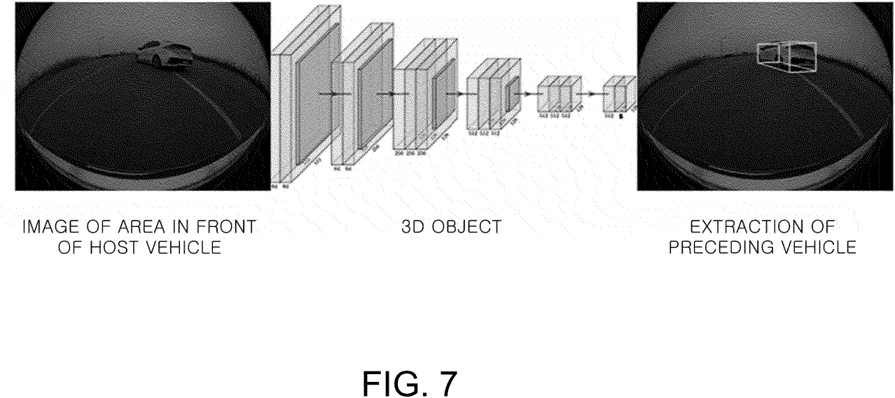

FIG. 3 is a flowchart illustrating the method of controlling activation of an object detection sensor according to the second embodiment of the present disclosure. FIGS. 4 and 5 are views that are referred to for description of a step of determining the presence or absence of the free space from the image of the area in front of the host vehicle in the method of controlling activation of an object detection sensor according to the second embodiment of the present disclosure. FIGS. 6 and 7 are views that are referred to for description of a step of extracting the preceding vehicle from the image of the area in front of the host vehicle in the method of controlling activation of an object detection sensor according to the second embodiment of the present disclosure.

With reference to FIG. 3, the controller 20 sets the operational mode of the front-side ultrasonic sensor to be a reception mode (S10) and determines whether or not an output signal value of the front-side ultrasonic sensor the operational mode of which is set to be the reception mode is at or above a preset reference value (S20). In Steps S10 and S20, it is determined whether or not the preceding vehicle that uses an ultrasonic sensor is present in the vicinity of the host vehicle.

In a case where it is determined in Step S20 that the output signal value of the front-side ultrasonic sensor is at or above the present reference value, the controller 20 determines that the preceding vehicle that uses the ultrasonic sensor is present in the vicinity of the host vehicle. Subsequently, the controller 20 determines whether or not the host vehicle moves a preset distance by traveling at a low vehicle speed within a preset speed range (S30). In Step S30, it is determined whether or not the host vehicle serves as a source that causes noise for the preceding vehicle. That is, only in a situation where the host vehicle is moved, the signal transmitted from the front-side ultrasonic sensor of the host vehicle serves as the source that causes noise for the preceding vehicle. Thus, there is a need to control whether or not to activate the front-side ultrasonic sensor. Therefore, by employing a technique of determining the above-mentioned “movement of the host vehicle,” the controller 20 determines whether or not the host vehicle moves a minimum distance at a minimum speed. By employing a quantitative analysis technique, the controller 20 determines whether or not the host vehicle travels at a low vehicle speed within the preset speed range and thus moves the preset distance. The preset speed range and the preset distance that vary according to a designer’s intention and an experimental result may be preset to be in the controller 20 (for example, the preset speed range is 0 to 5 km/h, and the preset distance is 20 cm).

In Step S30, in a case where it is determined that the host vehicle travels at a low vehicle speed within the preset speed range and thus moves the preset distance, from the image of the area in front of the host vehicle, which is acquired by the image acquisition unit 10, the controller 20 determines the presence or absence of the free space in front of the host vehicle (S40). In Step S40, by analyzing the number of pixels of the image of the area in front of the host vehicle, the controller 20 determines whether or not a central area in front of the host vehicle, a left-side area to the left of the central area, and a right-side area to the right of the central area correspond to the free space.

Specifically, a distance range where an ordinary ultrasonic sensor can perform detection is 1.2 m or shorter. Therefore, the ordinary ultrasonic sensor is used to notify a driver whether or not an obstacle is present adjacent to the host vehicle. The reaction time of a person is 100 ms or longer. Therefore, although a nearby obstacle is detected while the host vehicle travels at a vehicle speed of 43.2 km/h or faster, the driver cannot take action in response to the obstacle. Therefore, in a case where the front-side ultrasonic sensor is caused to operate at all times, in a situation where the host vehicle does not travel at a low vehicle speed, the effect of providing a warning against a nearby obstacle is seldom advantageous, and the host vehicle serves only as a source that causes noise for the preceding vehicle. In a case where a nearby obstacle is present in front of the host vehicle during traveling or a road is narrow, the front-side ultrasonic sensor needs to be activated. In Step S40, it is determined whether or not a nearby obstacle is present in front of the host vehicle or whether or not the road is narrow.

More specifically, in Step S40, the controller 20 converts the image of the area in front of the host vehicle to a bird-eye view and then determines whether or not the free space is present in front of the host vehicle, using a technique of applying a predefined image processing algorithm to the bird-eye view resulting from the conversion and performing analysis of the number of pixels of the image of the area in front of the host vehicle. The image processing algorithm described above may correspond to the semantic segmentation network. With the semantic segmentation network, it may be classified whether or not a class of pixels constituting the image of the area in front of the host vehicle correspond to an object (that is, an obstacle) or correspond to the free space. FIG. 4 is a view illustrating an example of operation of the semantic segmentation network.

In Step S40, the controller 20 may divide the area in front of the host vehicle into a central area, a left-side area to the left of the central area, and a right-side area to the right of the central area and may determine whether or not the area in front of the host vehicle corresponds to the free space. As illustrated in FIG. 5, the central area is an area with a preset width (a vehicle width) and a preset length (for example, 2 m), which is spaced, in the forward direction, away from the host vehicle. Moreover, the left-side area is an area with a preset width (for example, 50 cm) to the left of the central area, and the right-side area is an area with a preset width (for example, 50 cm) to the right of the central area. The central area, the left-side area, and the right-side area may be predefined in the controller 20. In a case where a ratio of the number of pixels of an image of each of the central area, the left-side area, and the right-side area in each of which an object is detected to the total number of pixels of the image of the detected area in front of the host vehicle is lower than a preset reference value (for example, 20%) (that is, in a case where the number of pixels of the image of each of the central area, the left-side area, and the right-side area accounts for less than 20% of the total number of pixels of the image of the area in front of the host vehicle), the controller 20 may determine that the corresponding area in front of the host vehicle corresponds to the free space.

In Step S40, when the central area, the left-side area, and the right-side area all satisfy the above-mentioned condition (the above-mentioned condition of 20%), the controller 20 determines that the area in front of the host vehicle corresponds to the free space and thus deactivates the front-side ultrasonic sensor (S50). Moreover, when none of the central area, the left-side area, and the right-side area satisfies the above-mentioned condition, the controller 20 determines that the area in front of the host vehicle does not correspond to the free space (that is, determines that an obstacle is present in front of the host vehicle or that a road in front of the host vehicle is narrow) and thus primarily determines that the front-side ultrasonic sensor needs to be activated (S60) (the front-side ultrasonic sensor may be kept activated until before the controller 20 secondarily determines subsequent Step S70 that the front-side ultrasonic sensor needs to be deactivated).

Subsequently to Step S60, the controller 20 analyzes the relative kinematic relationship between the preceding vehicle extracted from the image of the area in front of the host vehicle and the host vehicle (S70).

In Step S70, first, the controller 20 extracts the preceding vehicle from the image of the area in front of the host vehicle by applying a predefined object detection algorithm to the image of the area in front of the host vehicle. The object detection algorithm described above corresponds to the 3D object detection network that performs pre-learning in such a manner that the image of the area in front of the host vehicle is set to be input and that 3D positional information of an object present on the input image of the area in front of the host vehicle is output.

Regarding the learning by the 3D object detection network, as illustrated in FIG. 6, the controller 20 is configured to input an image and a label (coordinates of a 3D bounding box) into the 3D object detection network and to perform learning in such a manner that a 3D anchor box (that is, a bounding box at a candidate position at which the preceding vehicle is estimated to be positioned) recognizes a cut portion, so that an output of the 3D object detection network has values of 8 channels as in Equation 1 that follows.

$$\left(\frac{x - {x}_{a}}{{w}_{a}} , \frac{y - {y}_{a}}{{h}_{a}} , \frac{z - {z}_{a}}{{d}_{a}} , log \frac{w}{{w}_{a}} , log \frac{h}{{h}_{a}} , log \frac{d}{{d}_{a}} , \frac{θ - {θ}_{a}}{n} , c\right) \qquad \text{Equation 1}$$

In Equation 1, x, y, and z depict the center points of the bounding box surrounding a vehicle, w, h, d, and θ depict a horizontal length, a vertical length, a height, and a rotational angle, respectively, of the bounding box, and a depicts an anchor box. The 3D object detection network performs learning in such a manner that, only for a bounding box close to a position of a label, among 3D anchor boxes defined on the basis of output positions, respectively, values w, y, z, w, h, d, and θ that are deduced are the same as those of the label. For position and size variables (x, y, and z, and w, h, d, and θ) in Equation 1, the learning by the 3D object detection network is performed using a stochastic gradient descent method in which a loss is obtained using a mean square error and a cross entropy loss of c (0 depicts a background and 1 depicts a vehicle) is added to the obtained loss. The controller 20 may extract a 3D position of the preceding vehicle present on the image of the area in front of the host vehicle by inputting the image of the area in front of the host vehicle into the 3D object detection network that completes the learning as described above. FIG. 5 illustrates a step of inputting the image of the area in front of the host vehicle into the 3D object detection network and thus extracting the preceding vehicle.

In order to prevent from being influenced by a different vehicle (for example, a different vehicle that is already parked in a parking lot) that does not move on the image of the area in front of the host vehicle, the controller 20 extracts only a moving vehicle (that is, the preceding vehicle) by compensating for a movement of the host vehicle through the speed and the steering angle of the host vehicle and removing the different vehicle that does not move. The controller 20 analyzes the relative kinematic relationship between the preceding vehicle and the host vehicle on the basis of an angle between traveling directions of the preceding vehicle and the host vehicle, and on the basis of whether or not the traveling directions of the preceding vehicle and the host vehicle are opposite to each other.

The traveling direction of the preceding vehicle may be determined through an output of the 3D object detection network described above. That is, position and size parameters xₐ, yₐ, and zₐ, and wₐ, hₐ, dₐ, and θₐ of the anchor box in Equation 1 is preset to be in the controller 20. Because of this, when an output value of the 3D object detection network and xₐ, yₐ, zₐ, wₐ, hₐ, dₐ, and θₐ are substituted into Equation 1, x, y, z, w, h, d, and θ of the bounding box for the preceding vehicle are derived. The derived θ depicts a rotational angle of the preceding vehicle, that is, the traveling direction. Therefore, the controller 20 may calculate a difference between a steering angle of the host vehicle and the derived θ as an angle between the traveling directions of the preceding vehicle and the host vehicle. In addition, in a case where the host vehicle travels forward and the preceding vehicle travels backward, the traveling directions of the preceding vehicle and the host vehicle are opposite to each other. As described above, the movement of the host vehicle may be compensated for through the speed and the steering angle of the host vehicle, and the vehicle detected from the image of the area in front of the host vehicle may be recognized using a tracking technique.

Subsequently, in a case where the angle between the traveling directions of the preceding vehicle and the host vehicle is at or above a preset reference value or in a where the host vehicle travels forward and where the preceding vehicle travels backward, the controller 20 may secondarily determine that the front-side ultrasonic sensor needs to be deactivated. That is, in this case, a signal transmitted from the front-side ultrasonic sensor of the host vehicle causes interference with an object detection operation performed by the front-side or rear-side ultrasonic sensor of the preceding vehicle. Therefore, the controller 20 secondarily determines that the front-side ultrasonic sensor needs to be deactivated.

The controller 20 controls the activation of the front-side ultrasonic sensor on the basis of the result of the secondary determination in Step S70. That is, in the case where the angle between the traveling directions of the preceding vehicle and the host vehicle is at or above the preset reference value or in the case where the host vehicle travels forward and where the preceding vehicle travels backward, the controller 20 deactivates the front-side ultrasonic sensor. Conversely, in a case where the angle between the traveling directions of the preceding vehicle and the host vehicle is below the present reference value and in a case where the preceding vehicle does not travel backward, the controller 20 keeps the front-side ultrasonic sensor activated.

Consequently, according to the second embodiment of the present disclosure, in a case where the area in front of the host vehicle does not correspond to the free space (that is, in a case where a nearby obstacle is present), the driver is assisted in driving the host vehicle by activating the front-side ultrasonic sensor. However, in a case where the angle between the traveling directions of the host vehicle and the preceding vehicle is larger or in a case where the preceding vehicle that travels backward is present in front of the host vehicle, by deactivating the front-side ultrasonic sensor, the controller 20 may prevent the interference with the object detection operation performed by the front-side or rear-side ultrasonic sensor of the preceding vehicle.

In this manner, according to the first and second embodiments of the present disclosure, a technique of controlling the activation and the deactivation of the front-side ultrasonic sensor according to whether or not the area in front of the host vehicle corresponds to the free space is employed. This technique is more advantageous in terms of an improvement in convenience for the driver and a reduction in the risk of an accident than a technique of controlling the activation of the front-side ultrasonic sensor by operating a PDW switch. Even in a case where an obstacle is present in front of the host vehicle and thus the front-side ultrasonic sensor needs to be activated, when this activation causes the interference with the object detection operation performed by the front-side or rear-side ultrasonic sensor of the preceding vehicle located in front of the host vehicle, the probability that the ultrasonic sensor of the preceding vehicle will erroneously detect an object can be reduced by deactivating the front-side ultrasonic sensor.

The term “unit” used in the present disclosure may refer to a constituent element that is implemented in hardware, software, or firmware and, for example, may be used interchangeably with a term, such as a logic, a logical block, a component, or a circuit. The term “unit” may refer to an integrally configured component or a minimum unit or part of the integrally configured component that performs one or more functions. For example, according to the first embodiment of the present disclosure, a module may be implemented in the form of an application-specific integrated circuit (ASIC). In addition, features of the present disclosure that are described in the present specification may be realized as, for example, a method or process, an apparatus, a software program, a data stream, or a signal. The features, although described in context of a single form (for example, described as only in the form of a method), may also be realized in a different form (for example, in the form of an apparatus or a program). The apparatus may be implemented in the form of adequate hardware, software, firmware, or the like. The method may be realized in a device, such as a computer, a microprocessor, or a processor that generally refers to a processing device, such as, for example, an integrated circuit or a programmable logic device. The processor also includes a computer that facilitates communication of information between end users, a cellular phone, a portable/personal information terminal (a personal digital assistant (“PDA”), and other communication devices.

The embodiments of the present disclosure are described only in an exemplary manner with reference to the drawings. From this description, it would be understandable to a person of ordinary skill in the art to which the present disclosure pertains that various other modifications and equivalents are possibly made. Therefore, the proper technical scope of the present disclosure should be defined in the following claims.

What is claimed is:

1. An apparatus for controlling activation of an object detection sensor for detecting an object in front of a host vehicle, the apparatus comprising:
an image acquisition unit configured to acquire an image of an area in front of the host vehicle; and
a controller configured to control the activation of the object detection sensor based on a presence or absence of a free space in front of the host vehicle that is determined from the image of the area in front of the host vehicle and based on a relative kinematic relationship between a preceding vehicle extracted from the image of the area in front of the host vehicle and the host vehicle.

2. The apparatus of claim 1, wherein, when determining the presence or absence of the free space in front of the host vehicle, by analyzing a number of pixels of the image of the area in front of the host vehicle, the controller is configure to determine whether a central area in front of the host vehicle, a left-side area to the left of the central area, and a right-side area to the right of the central area correspond to the free space.

3. The apparatus of claim 2, wherein, in a case where a ratio of the number of pixels of an image of each of the central area, the left-side area, and the right-side area in which of each the object is detected to the number of the pixels of the image of the area in front of the host vehicle is lower than a preset reference value, the controller is configured to determine that the corresponding area in front of the host vehicle corresponds to the free space.

4. The apparatus of claim 2, wherein, when determining the presence or absence of the free space in front of the host vehicle, the controller is configured to convert the image of the area in front of the host vehicle to a bird-eye view and then determine a presence or absence of the free space in front of the host vehicle, using a technique of applying a predefined image processing algorithm to the bird-eye view resulting from the converted image and performing analysis of the number of pixels of the image of the area in front of the host vehicle.

5. The apparatus of claim 2, wherein, in a case where the area in front of the host vehicle does not correspond to the free space, the controller is configured to primarily determine that the object detection sensor needs to be activated.

6. The apparatus of claim 5, wherein the controller is configured to extract the preceding vehicle from the image of the area in front of the host vehicle by applying a predefined object detection algorithm to the image of the area in front of the host vehicle and analyze a relative kinematic relationship between the extracted preceding vehicle and the host vehicle based on an angle between traveling directions of the preceding vehicle and the host vehicle and based on whether the traveling directions of the preceding vehicle and the host vehicle are opposite to each other.

7. The apparatus of claim 6, wherein, in a case where the angle between the traveling directions of the preceding vehicle and the host vehicle is at or above a preset reference value or in a case where the host vehicle travels forward and where the preceding vehicle travels backward, the controller is configured to secondarily determine that the object detection sensor needs to be deactivated.

8. The apparatus of claim 6, wherein the object detection algorithm corresponds to a 3D object detection network configured to perform pre-learning such that the image of the area in front of the host vehicle is set to be input and that 3D positional information of the object present on the input image of the area in front of the host vehicle is output, and the controller is configured to obtain an angle between the traveling directions of the preceding vehicle and the host vehicle from an output of the object detection algorithm.

9. The apparatus of claim 1, wherein the object detection sensor is a front-side ultrasonic sensor, and a rear-side ultrasonic sensor for detecting the object behind the preceding vehicle is installed in the preceding vehicle, and
in a case where an output signal value of the front-side ultrasonic sensor that is initially set to be in a reception mode is at or above a preset reference value, after the host vehicle moves a preset distance by traveling at a low vehicle speed within a preset speed range, the controller is configured to start to perform an operation of controlling activation of the front-side ultrasonic sensor.

10. A method of controlling activation of an object detection sensor for detecting an object in front of a host vehicle, the method comprising:
determining, by a controller, a presence or absence of a free space in front of the host vehicle from an image of an area in front of the host vehicle;
analyzing, by the controller, a relative kinematic relationship between a preceding vehicle extracted from the image of the area in front of the host vehicle and the host vehicle in a case where the area in front of the host vehicle does not correspond to the free space; and
controlling, by the controller, the activation of the object detection sensor based on a result of analyzing the relative kinematic relationship between the preceding vehicle and the host vehicle.

11. The method of claim 10, wherein in the determining of the presence or absence of the free space, by analyzing a number of pixels of the image of the area in front of the host vehicle, the controller determines whether a central area in front of the host vehicle, a left-side area to the left of the central area, and a right-side area to the right of the central area correspond to the free space.

12. The method of claim 11, wherein in the determining of the presence or absence of the free space, in a case where a ratio of the number of pixels of an image of each of the central area, the left-side area, and the right-side area in which the object is detected to the number of the pixels of the image of the area in front of the host vehicle is lower than a preset reference value, the controller determines that the corresponding area in front of the host vehicle corresponds to the free space.

13. The method of claim 11, wherein in the determining of the presence or absence of the free space, the controller converts the image of the area in front of the host vehicle to a bird-eye view and determines the presence or absence of the free space in front of the host vehicle, using a technique of applying a predefined image processing algorithm to the bird-eye view resulting from the converted image and performing analysis of the number of the pixels of the image of the area in front of the host vehicle.

14. The method of claim 11, wherein in the determining of the presence or absence of the free space, in a case where the area in front of the host vehicle does not correspond to the free space, the controller primarily determines that the object detection sensor needs to be activated.

15. The method of claim 14, wherein in the analyzing of the relative kinematic relationship, the controller extracts the preceding vehicle from the image of the area in front of the host vehicle by applying a predefined object detection algorithm to the image of the area in front of the host vehicle and analyzes a relative kinematic relationship between the extracted preceding vehicle and the host vehicle based on an angle between traveling directions of the preceding vehicle and the host vehicle and based on whether the traveling directions of the preceding vehicle and the host vehicle are opposite to each other.

16. The method of claim 15, wherein in the analyzing of the relative kinematic relationship, in a case where the angle between the traveling directions of the preceding vehicle and the host vehicle is at or above a preset reference value or in a case where the host vehicle travels forward and where the preceding vehicle travels backward, the controller secondarily determines that the object detection sensor needs to be deactivated.

17. The method of claim 15, wherein the object detection algorithm corresponds to a 3D object detection network that performs pre-learning such that the image of the area in front of the host vehicle is set to be input and that 3D positional information of the object present on the input image of the area in front of the host vehicle is output, and in the analyzing of the relative kinematic relationship, the controller obtains an angle between the traveling directions of the preceding vehicle and the host vehicle from an output of the object detection algorithm.

18. The method of claim 10, further comprising, before the determining of the presence or absence of the free space:
determining, by the controller, whether an output signal value of a front-side ultrasonic sensor that is initially set to be in a reception mode is at or above a preset reference value; and
determining, by the controller, whether the host vehicle moves a preset distance by traveling at a low vehicle speed within a preset speed range, in a case where the output signal value of the front-side ultrasonic sensor is at or above the preset reference value,
wherein the object detection sensor is the front-side ultrasonic sensor, and a rear-side ultrasonic sensor for detecting the object behind the preceding vehicle is installed in the preceding vehicle, and the determining of the presence or absence of the free space is performed by the controller in a case where the host vehicle moves the preset distance by traveling at the low vehicle speed within the preset speed range.
